(19) United States
(12) Patent Application Publication
(10) Pub. No.: US 2006/0088743 A1
(43) Pub. Date: Apr. 27, 2006

(54) Fuel cell system method and apparatus

(76) Inventors: Emerson R. Gallagher, Vancouver (CA); Jeffrey D. Glandt, Vancouver (CA)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 11/253,057

(22) Filed: Oct. 18, 2005

Related U.S. Application Data
(60) Provisional application No. 60/620,887, filed on Oct. 20, 2004.

(51) Int. Cl. H01M 8/00

(52) U.S. Cl. 429/13; 429/12

(57) ABSTRACT

A fuel cell system employs at least two fuel cell stacks electrically coupled in parallel to reduce the load turndown ratio of the fuel cell stacks. Fewer than all fuel cell stacks may be operated where the power demand permits. An oxidant supply subsystem may cease supplying oxidant to one of the fuel cell stacks to stop operation (power production) from the fuel cell stack. The fuel cell stacks may take turns at being the non-operating fuel cell stack.

### BACKGROUND OF THE INVENTION

1. Field of the Invention

This disclosure generally relates to fuel cell systems suitable for producing electrical power.

2. Description of the Related Art

Electrochemical fuel cells convert fuel and oxidant to electricity. Solid polymer electrochemical fuel cells generally employ a membrane electrode assembly (“MEA”) which includes an ion exchange membrane or solid polymer electrolyte disposed between two electrodes typically comprising a layer of porous, electrically conductive sheet material, such as carbon fiber paper or carbon cloth. The MEA contains a layer of catalyst, typically in the form of finely comminuted platinum, at each membrane electrode interface to induce the desired electrochemical reaction. In operation, the electrodes are electrically coupled for conducting electrons between the electrodes through an external circuit. Typically, a number of MEAs are electrically coupled in series to form a fuel cell stack having a desired power output.

In typical fuel cells, the MEA is disposed between two electrically conductive fluid flow field plates or separator plates. Fluid flow field plates have flow passages to direct fuel and oxidant to the electrodes, namely the anode and the cathode, respectively. The fluid flow field plates act as current collectors, provide support for the electrodes, provide access channels for the fuel and oxidant, and provide channels for the removal of reaction products, such as water formed during fuel cell operation. The fuel cell system may use the reaction products in maintaining the reaction. For example, reaction water may be used for hydrating the ion exchange membrane and/or maintaining the temperature of the fuel cell stack.

Fuel cell stacks are typically designed for maximum power conditions. In existing fuel cell systems, flow is increased at idle power conditions to provide enough pressure drop for water management. The flows required to generate this pressure drop at idle power conditions are large (with respect to the required stoichiometry, stoichiometry being the ratio of fuel or oxidant supplied to that consumed in the generation of electrical power in the fuel cell) and significantly reduce the efficiency of the fuel cell system. Attempts have been made to reduce these flows and pressure drops, but these attempts decrease the robustness and reliability of the fuel cell stack under idle conditions. A fuel cell system that is robust, reliable and efficient under both maximum and idle power conditions would be highly desirable.

### BRIEF SUMMARY OF THE INVENTION

In one aspect, a power system comprises a first set of fuel cells electrically coupled to provide a first voltage when the first set of fuel cells is operating; at least a second set of fuel cells electrically coupled to provide a second voltage when the second set of fuel cells is operating; a first diode comprising an anode and a cathode, the anode of the first diode electrically coupled to the first set of fuel cells to pass a current produced by the first set of fuel cells when the first set of fuel cells is operating; a second diode comprising an anode and a cathode, the anode of the second diode electrically coupled to the second set of fuel cells to pass a current produced by the second set of fuel cells when the second set of fuel cells is operating, the cathode of the first diode electrically coupled to the cathode of the second diode. In some embodiments, the power system may comprise a third or fourth set of fuel cells, or even additional sets of fuel cells.

In another aspect, a method of operating a fuel cell system comprises, during a first period when a demand for power is above a crossover threshold, providing a flow of a fuel to at least first and second sets of fuel cells, and providing a flow of an oxidant to at least the first and the second sets of fuel cells, and, during a second period when the demand for power is below the crossover threshold, providing the flow of the fuel to at least the first and the second sets of fuel cells, providing the flow of the oxidant to the first set of fuel cells, and terminating the flow of the oxidant to the second set of fuel cells.

In a further aspect, a method of operating a fuel cell system comprises operating each of the sets of fuel cells to produce power when a demand for power is above a crossover threshold, and terminating operation of alternating ones of the sets of fuel cells each time the demand for power is below the crossover threshold. Operating the set of fuel cells may comprise providing a flow of a fuel and a flow of an oxidant to the fuel cells comprising the respective set of fuel cells. Terminating the operation of the set of fuel cells may comprise providing the flow of the fuel while ceasing the flow of the oxidant to the fuel cells comprising the respective set of fuel cells.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic diagram of a fuel cell system comprising first and second fuel cell stacks and showing an electrical configuration of the fuel cell system according to one illustrated embodiment.

FIG. 2 is a schematic diagram of the fuel cell system of FIG. 1, showing a flow configuration of the fuel cell system according to one illustrated embodiment.

FIG. 3 is a schematic diagram of the fuel cell system of FIG. 1, showing a flow configuration of the fuel cell system according to another illustrated embodiment.

FIG. 4 is graph showing a polarization curve of the fuel cell system of FIGS. 1 and 2 according to one illustrated embodiment.

### DETAILED DESCRIPTION

In the following description, certain specific details are set forth in order to provide a thorough understanding of various embodiments. However, one skilled in the relevant art will recognize that the teachings here may be practiced without one or more of these specific details, or with other methods, components, materials, etc. In other instances, well-known structures associated with fuel cell systems including the various operating and control components commonly referred to as balance of plant (BOP) have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment of the present fuel cell systems. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

The headings provided herein are for convenience only and do not interpret the scope or meaning of the claimed invention.

As noted above, prior fuel cell system designs employed fuel cell stacks designed for maximum power conditions. At idle power conditions, flow was increased to provide sufficient pressure drop for water management. The flows required to generate this pressure drop are large and significantly reduce the efficiency of the fuel cell system. Attempts to reduce these flows and pressure drops have decreased the robustness and reliability of the fuel cell stack under idle conditions.

Applicants have recognized that large turn down ratios (i.e., max load/idle load) make it difficult to design a fuel cell stack which can supply maximum power without violating system limits (pressure drop, flow, etc.) and run efficiently and robustly at idle power. Operating stacks configured in parallel both electrically and with respect to supply subsystems can advantageously reduce the turn down ratio that the fuel cell stack is required to operate under.

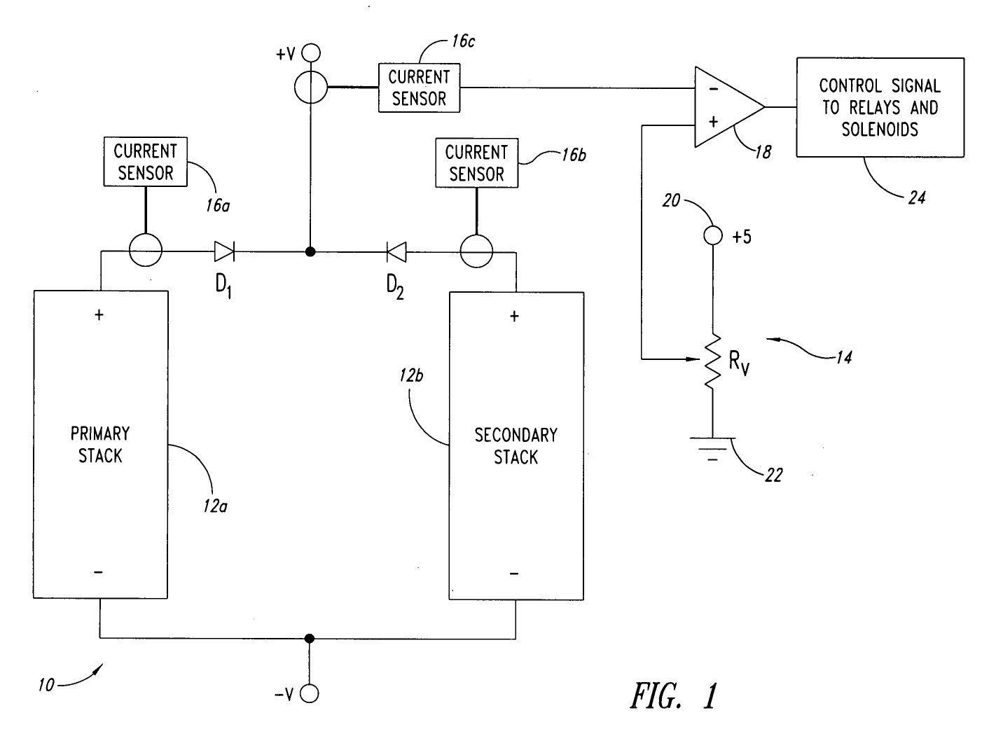

FIG. 1 shows a fuel cell system 10 comprising a first fuel cell stack 12a and a second fuel cell stack 12b electrically coupled in parallel via first and second diodes D₁, D₂ to provide a primary voltage source indicated by positive potential +V and negative or ground potential −V. The fuel cell stacks 12a, 12b may, for example, take the form of Nexa® power modules, available from Ballard Power of Burnaby, B.C., Canada.

The fuel cell system 10 comprises a control system 14, which may include a first stack current sensor 16a, a second stack current sensor 16b and a total stack current sensor 16c. The first stack current sensor 16a is coupled to sense a current produced by the first fuel cell stack 12a, while the second stack current sensor 16b is coupled to sense a current produced by the second fuel cell stack 12b. The total stack current sensor 16c is coupled to sense the total current produced by the first and second fuel cell stacks 12a, 12b.

The control system 14 further comprises a comparator 18, for example a differential amplifier, coupled to compare the total current sensed by the total stack current sensor 16c to a threshold value. The threshold value may be set via a variable resistor R_{V} coupled between a voltage source (e.g., +5V) 20 and ground 22. The comparator 18 can provide control signals 24 to relays and/or solenoids, as discussed in more detail below.

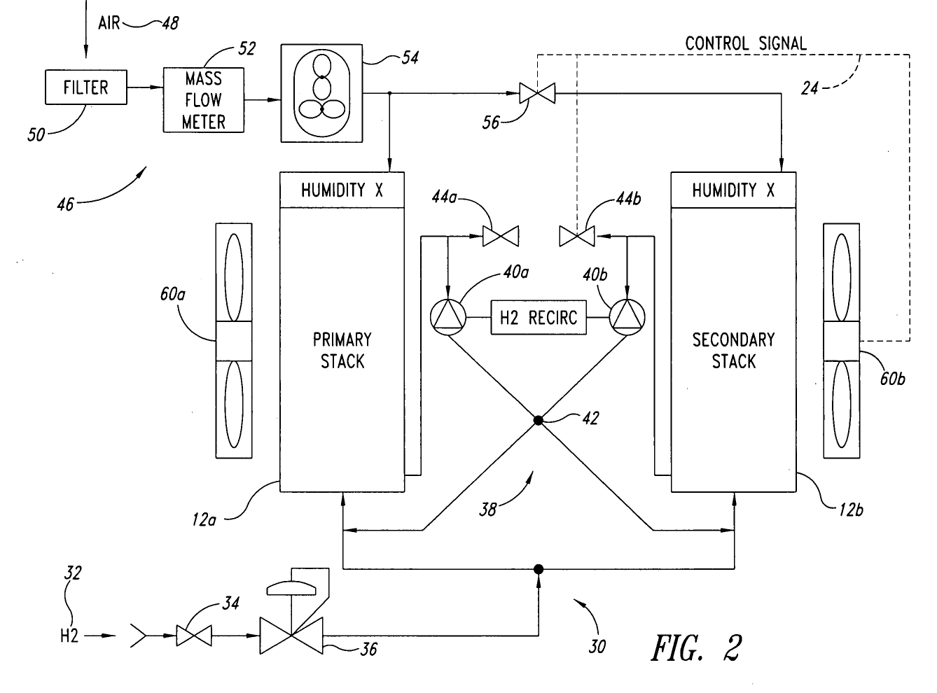

FIG. 2 shows the various supply subsystems of the fuel cell system 10 of FIG. 1. The fuel cell system 10 comprises a fuel supply subsystem 30 including a fuel source 32, an inlet valve 34, and a regulator 36 to regulate the supply of fuel to the first and second fuel cell stacks 12a, 12b via appropriate conduits and/or manifolds (illustrated by arrows extending between the elements of the fuel supply subsystem 30 and the fuel cell stacks 12a, 12b). A broad range of reactants can be used in solid polymer electrolyte fuel cells. For example, the fuel stream may be substantially pure hydrogen gas, a gaseous hydrogen-containing reformate stream, or methanol in a direct methanol fuel cell.

Where the fuel used is pressurized hydrogen, the fuel supply subsystem 30 may advantageously utilize fuel recirculation subsystem 38. The fuel recirculation subsystem 38 of the fuel supply subsystem 30 may comprise one or more fuel delivery devices 40a, 40b such as pumps, compressors and/or blowers. The fuel recirculation subsystem 38 may also comprise one or more mixers 42 to mix recirculated fuel coming from the fuel cell stacks 12a, 12b with fuel from the fuel source 32. The fuel supply subsystem 30 may comprise one or more purge valves 44a, 44b for purging the anodes of the fuel cell stacks 12a, 12b.

The fuel cell system 10 may further comprise an oxidant supply subsystem 46 to supply an oxidant, for example oxygen or air, to the fuel cell stacks 12a, 12b. The oxidant supply subsystem 46 may supply air from a source 48, for example the ambient environment. The oxidant supply subsystem 46 may comprise a filter 50 to filter the air, a mass flow meter 52 to determine a magnitude of the air flow and/or an oxidant delivery device 54 to transfer the air at suitable pressure to the fuel cell stacks 12a, 12b via appropriate conduits and/or manifolds (illustrated by arrows extending between the elements of the oxidant supply subsystem 46 and the fuel cell stacks 12a, 12b). The oxidant delivery device 54 may take the form of a compressor, fan or blower, such as the Roots blower shown schematically in FIG. 2. The air supply subsystem 46 may comprise one or more air supply valves 56, operable to control flow of air to a respective one of the fuel cell stacks 12a, 12b.

The fuel cell system 10 may further comprise a stack temperature regulating subsystem. The stack temperature regulating subsystem may provide a heat transfer medium to the fuel cell stacks 12a, 12b to regulate the temperature of the fuel cell stacks 12a, 12b or ambient environment adjacent the fuel cell stacks 12a, 12b. The heat transfer medium may take a variety of forms for example, a fluid such as a liquid and/or a gas. As illustrated, the stack temperature regulating subsystem comprises a first heat transfer medium delivery device 60a and a second heat transfer medium delivery device 60b, each of the heat transfer medium delivery devices 60a, 60b operable to supply a heat transfer medium flow across the fuel cell stacks 12a, 12b. In some embodiments the heat transfer medium delivery devices 60a, 60b may take the form of fans or blowers operable to blow a stream of air over the fuel cell stacks 12a, 12b. Alternatively, or additionally, the heat transfer medium delivery devices 60a, 60b may take the form of pumps and/or compressors to direct the heat transfer medium to and/or away from the fuel cell stacks 12a, 12b. It is noted that while the heat transfer medium is often used to transport heat from the fuel cell stacks 12a, 12b, in some instances the heat transfer medium may be employed to transport heat to the fuel cell stacks 12a, 12b, for example during startup of the fuel cell stacks 12a, 12b.

As illustrated in FIGS. 1 and 2, the fuel cell stacks 12a, 12b are configured in parallel, both electrically and with respect to the flow subsystems. One or more of the air supply valve 56, purge valves 44a, 44b, and heat transfer medium delivery devices 60a, 60b may be responsive to the control signals (indicated by broken line) 24.

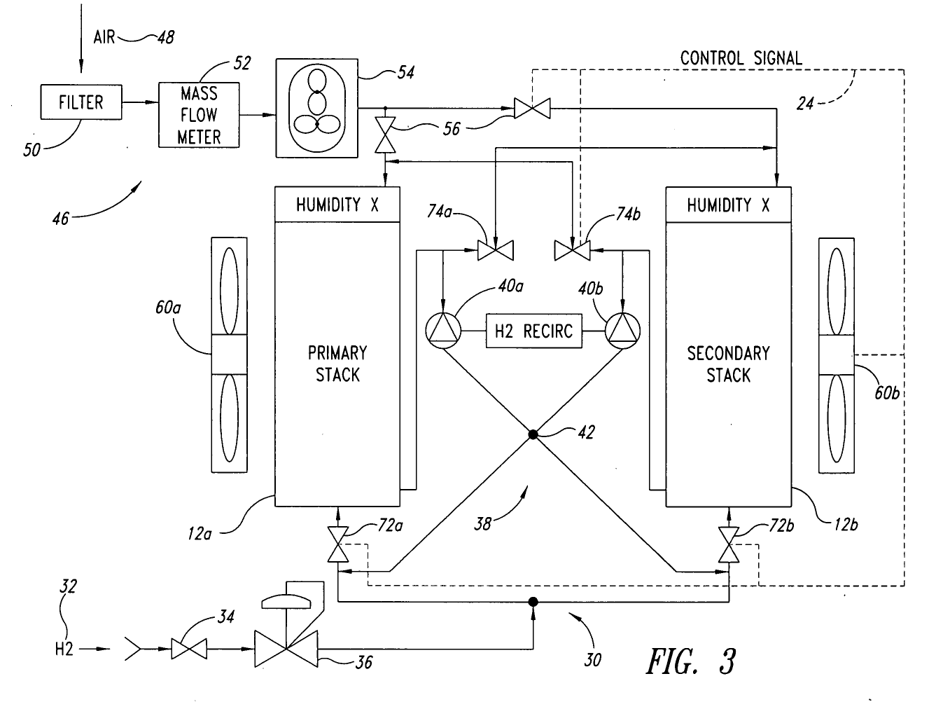

Referring to FIG. 3, in one embodiment, gasses purged from the anodes of the fuel cell stacks 12a, 12b, may be purged directly to atmosphere. In another embodiment, gasses purged from the anodes of the fuel cell stacks 12a, 12b, may be directed into the cathode of at least one of the other fuel cell stacks 12a, 12b. In yet another embodiment, gasses purged from the anodes of the fuel cell stacks 12a, 12b may be directed either to atmosphere or into the cathode of the other of the fuel cell stacks 12a, 12b. This may be achieved by use of three way purge valves 74a, 74b. One skilled in the art will appreciate that other valve setups exist that may achieve the same results. Additional devices, such as water separators (not shown) may be used to remove moisture from the purged gasses before their introduction into the cathodes of fuel cell stacks 12a, 12b.

In another embodiment, the fuel supply subsystem 30 may comprise one or more fuel supply valves 72a, 72b, operable to control flow of fuel to a respective one of the fuel cell stacks 12a, 12b. One or more of the air supply valve 56, fuel supply valves 72a, 72b, purge valves 74a, 74b, and heat transfer medium delivery devices 60a, 60b may be responsive to control signals (indicated by broken line) 24.

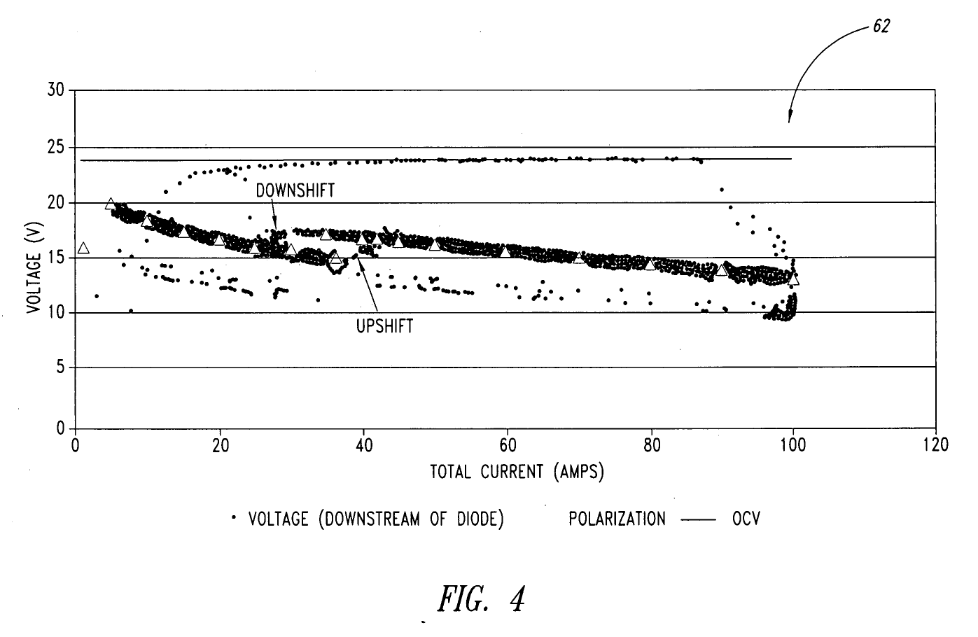

FIG. 4 shows a polarization curve 62 for the fuel cell system 10 topology of FIGS. 1 and 2 employing two 24-cell Nexa® power module fuel cell stacks.

In operation, the fuel cell system 10 may operate in two states, an idle state and a non-idle state. The idle state is triggered when the power demand placed on the fuel cell system 10 is below a crossover threshold, for example at or below one half the maximum power of the fuel cell system 10. The non-idle state is triggered when the power demand placed on the fuel cell system is above the crossover threshold, for example at or above one half the maximum power of the fuel cell system 10.

In the idle state, one of the fuel cell stacks 12a, 12b, for example the first fuel cell stack 12a, supplies the required power while the other one of the fuel cell stacks 12a, 12b, for example the second fuel cell stack 12b, does not supply power, and may be considered as non-operational.

The voltage across the non-operational fuel cell stack 12a, 12b, for example the second fuel cell stack 12b, is limited to be no greater than the voltage across the operating fuel cell stack 12a, 12b, for example the first fuel cell stack 12a, through the use of the diodes D₁, D₂.

In other embodiments, diodes D₁, D₂ may be replaced by other devices that perform a similar function. For example diodes D₁, D₂ may be replaced by switches that are controlled to perform similar functions to diodes D₁, D₂. Said switches may be controlled to ensure that the voltage across the non-operational stack is limited to be no greater than the voltage across the operating fuel cell stack. Simultaneously, said switches could be controlled to ensure that power (or current) does not flow from the operating stack into the non-operating stack.

In another embodiment the switches may be controlled such that the voltage across the non-operating stack does not exceed the open circuit voltage (OCV) of the fuel cell stack. The open circuit voltage in this case is defined as the maximum voltage produced by a fuel cell stack when oxidant and fuel are present in said fuel cell stack, and an electrical load is not attached to the fuel cell stack. For example, for a proton exchange membrane (PEM) type fuel cell with hydrogen as the fuel and air as the oxidant, the OCV is typically in the range of approximately 0.9V to 1.2V. Said switches may preferably be solid state switches such as solid state relays (SSRs), insulated gate bipolar transistors (IGBTs), field effect transistors (FETs), metal oxide semiconductor field effect transistors (MOSFETs), and/or other semiconductor switches. One skilled in the art will appreciate that any suitable switching device, or like controllable devices having similar operating functionality, may be used for this purpose.

In the idle state, the fuel may be recirculated through both of the fuel cell stacks 12a, 12b, with a periodic purge via purge valves 44a, 44b (or purge valves 74a, 74b). However air is only supplied to the operating one of the fuel cell stacks 12a, 12b, in order to reduce the possibility of corrosion by limiting the presence of oxygen.

In another embodiment, the gasses purged from the anode of the operating stack may be directed into the cathode of the non-operating stack. Supplying fuel to the anode of the non-operating stack while not supplying gasses to the cathode of the non-operating stack may result in some fuel loss due to fuel migration across the membrane. Filling the cathode of the non-operating stack with fuel purged from the operating stack may advantageously reduce this loss.

In another embodiment, fuel supply to the non-operating stack may be suspended after air is no longer supplied to the non-operating stack. This may further advantageously reduce fuel losses.

In the idle state, the heat transfer medium may or may not be supplied to the non-operating one of the fuel cell stacks 12a, 12b, depending on the rate of heat loss to the environment and the sensitivity of the fuel cell stacks 12a, 12b and the fuel cell system 10 to loss of heat and temperature change along the non-operating fuel cell stack 12a, 12b.

When the demand for power increases and is approximately equal to the crossover threshold, the previously non-operating one of the fuel cell stacks 12a, 12b is activated, for example, by supplying air to the fuel cell stack 12a, 12b through the air supply valve 56. The previously operating fuel cell stack 12a, 12b is reduced to supplying half of the total system power and the non-operating fuel cell stack 12a, 12b supplies the remaining half of the total system power. Thus, above the crossover threshold, both fuel cell stacks 12a, 12b are operated to each supply approximately half the demanded power.

In one method of operation, the fuel cell system 10 leaves one of the fuel cell stacks 12a, 12b, for example the first fuel cell stack 12, operating continuously while there is a demand for power without regard to the crossover threshold. In this method the fuel cell system toggles the other one of the fuel cell stacks 12a, 12b, for example the second fuel cell stack 12b, between the operating and non-operating states based on the comparison of the power demand with the crossover threshold. This approach concentrates the effects of the start/stop process on one of the fuel cell stacks 12a, 12b.

In another method of operation, the fuel cell system 10 alternates which one of the fuel cell stacks 12a, 12b is run continuously and which is toggled based on the comparison of the demand with the crossover threshold. This approach may advantageously apportion the wear associated with ON/OFF cycles and/or with operation at low load conditions between the various fuel cell stacks 12a, 12b.

As an example, in a fuel cell system requiring a maximum current draw of 312A and an idle current draw of 2A, a conventionally designed and operated fuel cell stack would need to be designed so as to operate at 312A and 2A, a load turndown ratio of 156. However, a fuel cell system 10 employing the above described approach, would advantageously employ fuel cell stacks 12a, 12b designed to operate at 156A and 2A, halving the load turndown ratio.

In addition to reducing the turndown ratio, the above described approach may provide several other possible benefits. By effectively doubling the current density on the operating fuel cell stack 12a, 12b at low loads below the crossover threshold, the time spent at high cell voltages is reduced. This may advantageously reduce membrane degradation. This may also advantageously reduce the possibility of high potential based cathode corrosion. Assuming that the start, stop, and hibernation conditions are benign, the life of the total system may be increased by dividing the operational hours at low loads between the two or more fuel cell stacks 12a, 12b. (Hibernation is the non-power producing state the non-operating stack enters when system power demands are less than the cross-over demand. It may not be the same as an “off” state.)

From a system view, the cutoff of air to half the fuel cells doubles the pressure drop per unit of flow on the cathode side of the fuel cells. Assuming that at idle the oxidant delivery device 54 must supply enough airflow to maintain a critical minimum pressure drop, the flow rate to achieve this is approximately half that of a non-switching fuel cell system with the same high power flow/pressure drop characteristics. This can reduce the parasitic load on oxidant delivery device 54 by approximately 50% below the crossover point. Additionally, if the heat transfer medium flow to the non-operating fuel cell stack is also cut off, there is a corresponding reduction in the heat transfer medium delivery device 60a, 60b parasitic load as well, although this reduction may not be as high as 50%.

Finally, electrically coupling multiple fuel cell stacks 12a, 12b in parallel increases redundancy. Should one the fuel cell stacks 12a, 12b fail, the remaining fuel cell stack is still capable of supplying 50% of maximum power. In some embodiments, the fuel cell system 10 may supply greater than 50% of maximum power where fewer than half of the fuel cell stacks fail. This redundancy allows the fuel cell system 10 to implement a “limp-home” mode, that can allow the fuel cell system 10 to continue functioning at a reduced capability until the fuel cell system 10 can be serviced. This may, for example, allow an electric or hybrid vehicle to move to a secure location such as a breakdown lane, a repair shop, and/or operator's home. Additionally, or alternatively, this may allow the backup of data and performance of an orderly shut down routine, for example in either a mobile application or a stationary application.

The fuel cell system 10 may be designed without fuel recirculation subsystem 38 which would reduce complexity and cost, but may reduce fuel efficiency. Each fuel cell stack 12a, 12b does not necessarily require a respective purge valve 44a, 44b, again reducing complexity. While the heat transfer medium delivery device 60a, 60b may continue to provide the heat transfer medium to the fuel cell stack 12a, 12b after the fuel cell stack 12a, 12b ceases producing power, ceasing the flow of the heat transfer medium to the non-operating one of the fuel cell stacks 12a, 12b may advantageously maintain a temperature gradient along the flow fields of the non-operating one of the fuel cell stacks 12a, 12b.

It may be advantageous to maintain more than just binary (e.g., ON/OFF) control over the heat transfer medium (e.g., airflow) between the two fuel cell stacks 12a, 12b. Having some control over the volume and or speed of the flow of the heat transfer medium between the fuel cell stacks 12a, 12b allows for better load and flow balancing. In addition, long periods of non-operation can leave one of the fuel cell stacks 12a, 12b colder than the other, and without a temperature gradient (dT) along the length of the flow fields of the non-operating one of the fuel cell stacks 12a, 12b. This adversely affects the pressure drop causing flow sharing inequities when the non-operating one of the fuel cell stacks 12a, 12b is restarted. These flow sharing inequities will also exist between the fuel cell stack 12a, 12b which is starting up and the fuel cell stack 12a, 12b which has been operating.

Future automotive systems with high turndown, long life and high reliability requirements could utilize the above described approach. In addition, the redundancy aspects of above described approach may also make it applicable to stationary systems. The ability to turn ON individual fuel cell stacks can be used as part of an exercising routine in fuel cell based systems with low frequency start-up. For example, such an exercise routine may be implemented in an uninterruptible power supply systems (UPS) application, such as a power supply backup for telecommunications switching offices. The above described approach may advantageously prevent cathode corrosion and membrane degradation by not allowing the voltage across the non-operating fuel cell stack 12a, 12b to rise to open voltage condition (OVC) when not in use, by using diodes D₁, D₂ between the fuel cell stacks 12a, 12b rather than contactors or relays.

Continuous fuel recirculation may also advantageously prevent cathode corrosion due to fuel starvation, minimizing degradation during restarts of the fuel cell stacks 12a, 12b. The diodes D₁, D₂ allow the voltage across the non-operating one of the fuel cell stacks 12a, 12b to almost immediately begin to bleed down over time. Transient voltage cathode corrosion may be reduced or eliminated.

As discussed above, some of the advantages may include reduced turndown requirement of the fuel cell, reduced time spent at high cell voltages and consequently reduced membrane degradation and cathode corrosion. Also as discussed above, some of the advantages may additionally or alternatively include increased total fuel cell system lifetime due to splitting low load hours between multiple stacks. Some of the advantages may additionally or alternatively include reduced cathode blower parasitic losses at low loads. Some of the advantages may additionally or alternatively include improved redundancy of the fuel cell system 10, for example, provision of a limp-home mode.

While discussed above in terms of a two stack configuration, the fuel cell system 10 may include a greater number of unit fuel cell stacks 12a, 12b which may advantageously contribute to decreasing the turndown ratio and increasing the reliability and redundancy.

As used herein the term fuel cell stack refers to one or more fuel cells electrically coupled together that produce a voltage across a pair of nodes or terminals. Thus, in one embodiment, the two or more fuel cell stacks may be distinct stack structures, each a physically separate collection of fuel cells electrically and mechanically coupled together, and each comprising a respective pair of nodes or terminals. In another embodiment, the two or more fuel cell stacks may be portions of a single integral structure with the fuel cells of all fuel cell stacks electrically and mechanically coupled together. In such an embodiment a common tap node or terminal is shared between the fuel cell stacks and thereby divides the structure into two or more portions. The common tap node or terminal may, or may not, be at a center point in the structure.

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, such as one or more computer programs running on one or more computers (e.g., as one or more programs running on one or more computer systems), as one or more programs running on one or more controllers (e.g., microcontrollers), as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the control mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

As used herein and in the claims, the term “set of fuel cells” refers to any number of fuel cells that are electrically coupled to produce a voltage thereacross. While the set of fuel cells will most often be associated with a stack of fuel cells, the fuel cells of the set may, or may not, be mechanically coupled together, and may comprise as few as a single fuel cell. The term “demand for power” refers to a current, voltage or power draw of the load, whether the load comprises the electric machine 14 and/or an intermediary device.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, including but not limited to:

U.S. Pat. No. 6,573,682, issued Jun. 3, 2003;

U.S. patent publication Nos. 2003/0022038, 2003/0022036, 2003/0022040, 2003/0022041, 2003/0022042, 2003/0022037, 2003/0022031, 2003/0022050, and 2003/0022045, all published Jan. 30, 2003; 2003/0113594 and 2003/0113599, both published Jun. 19, 2003; 2004/0009380, published Jan. 15, 2004; and 2004/0126635, published Jul. 1, 2004;

U.S. patent application Ser. Nos. 10/817,052, filed Apr. 2, 2004; Ser. No. 10/430,903, filed May 6, 2003; Ser. No. 10/440,512, filed May 16, 2003; Ser. No. 10/875,797 and 10/875,622, both filed Jun. 23, 2004; Ser. No. 10/664,808, filed Sep. 17, 2003; Ser. No. 10/964,000, filed Oct. 12, 2004; and Ser. No. 10/861,319, filed Jun. 4, 2004; and

U.S. provisional patent application Ser. Nos. 60/569,218, filed May 7, 2004; 60/560,755, filed Jun. 4, 2004; and 60/621,012, filed Oct. 20, 2004, using Express Mail No. EV529821615US, and entitled “POWER SYSTEM METHOD AND APPARATUS”; are incorporated herein by reference, in their entirety. Aspects of the present systems and methods can be modified, if necessary, to employ systems, circuits and concepts of the various patents, applications and publications to provide yet further embodiments of the invention.

These and other changes can be made to the present systems and methods in light of the above-detailed description. In general, in the following claims, the terms used should not be construed to limit the invention to the specific embodiments disclosed in the specification and the claims, but should be construed to include all power systems and methods that read in accordance with the claims. Accordingly, the invention is not limited by the disclosure, but instead its scope is to be determined entirely by the following claims.

1. A power system, comprising:
a first set of fuel cells electrically coupled to provide a first voltage when the first set of fuel cells is operating;
at least a second set of fuel cells electrically coupled to provide a second voltage when the second set of fuel cells is operating;
a first diode comprising an anode and a cathode, the anode of the first diode electrically coupled to the first set of fuel cells to pass a current produced by the first set of fuel cells when the first set of fuel cells is operating;
a second diode comprising an anode and a cathode, the anode of the second diode electrically coupled to the second set of fuel cells to pass a current produced by the second set of fuel cells when the second set of fuel cells is operating, the cathode of the first diode electrically coupled to the cathode of the second diode.

2. The power system of claim 1, further comprising:
a fuel supply subsystem operable to supply fuel to the first and the second sets of fuel cells; and
an oxidant supply subsystem operable to supply oxidant to the first and the second sets of fuel cells.

3. The power system of claim 2 wherein the oxidant supply subsystem comprises at least one oxidant supply valve operable to control a flow of oxidant to one of the first or the second sets of fuel cells.

4. The power system of claim 3, further comprising:
a controller coupled to control the oxidant supply valve to terminate the flow of oxidant to the one of the first or the second sets of fuel cells in response to a load demand being below a crossover threshold.

5. The power system of claim 4 wherein the fuel supply subsystem continues to supply fuel to the first and the second sets of fuel cells when the flow of oxidant to the one of the first or the second sets of fuel cells is terminated.

6. The power system of claim 4 wherein the fuel supply subsystem comprises at least one fuel supply valve operable to control a flow of fuel to one of the first or the second sets of fuel cells.

7. The power system of claim 6 wherein the controller is further coupled to control the fuel supply valve to terminate the flow of fuel to the one of the first or the second sets of fuel cells in response to the flow of oxidant to the one of the first or the second sets of fuel cells being terminated.

8. The power system of claim 4 wherein the controller comprises a comparator that from time-to-time compares a total current drawn from the first and the second sets of fuel cells to the crossover threshold.

9. The power system of claim 2 wherein the fuel supply subsystem comprises a fuel recirculation subsystem coupled to recirculate fuel from the first and the second sets of fuel cells.

10. The power system of claim 9 wherein the fuel recirculation subsystem comprises a mixer coupled to mix recirculated fuel between the first and the second sets of fuel cells.

11. The power system of claim 2 wherein the fuel supply subsystem comprises at least one purge valve coupled to at least one of the first or the second sets of fuel cells and operable to purge an anode of the first or the second set of fuel cells.

12. The power system of claim 2 wherein the fuel supply subsystem comprises at least one purge valve coupled to both the first and the second sets of fuel cells and operable to communicate the purge gasses from an anode of one of the first or the second set of fuel cells to the cathode of the other of the first or the second sets of fuel cells.

13. The power system of claim 2 wherein the first set of fuel cells is mechanically coupled as a first fuel cell stack and wherein the second set of fuel cells is mechanically coupled as a second fuel cell stack physically separate from the first fuel cell stack.

14. A method of operating a fuel cell system comprising at least a first and a second set of fuel cells, the fuel cells in the first set of fuel cells electrically coupled in series to one another and operable to produce a voltage thereacross, the fuel cells in the second set of fuel cells electrically coupled in series to one another and operable to produce a voltage thereacross, and at least the first and the second sets of fuel cells electrically coupled in parallel to one another via respective ones of diodes, the diodes commonly coupled at respective cathodes thereof, the method comprising:
during a first period when a demand for power is above a crossover threshold,
providing a flow of a fuel to at least the first and the second sets of fuel cells; and
providing a flow of an oxidant to at least the first and the second sets of fuel cells; and
during a second period when the demand for power is below the crossover threshold,
providing the flow of the fuel to at least the first and the second sets of fuel cells;
providing the flow of the oxidant to the first set of fuel cells; and
terminating the flow of the oxidant to the second set of fuel cells.

15. The method of claim 14, the method further comprising:
during a third period when the demand for power is below the crossover threshold,
providing the flow of the fuel to at least the first and the second sets of fuel cells;
providing the flow of the oxidant to the second set of fuel cells; and
terminating the flow of the oxidant to the first set of fuel cells.

16. A method of operating a fuel cell system comprising at least two sets of fuel cells, the fuel cells in each of the sets of fuel cells electrically coupled in series to one another, each of the sets of fuel cells electrically coupled in parallel to one another, the method comprising:
operating each of the sets of fuel cells to produce power when a demand for power is above a crossover threshold; and
terminating operation of alternating ones of the sets of fuel cells each time the demand for power is below the crossover threshold.

17. The method of claim 16 wherein for each of the sets of fuel cells, operating the set of fuel cells comprises providing a flow of a fuel and a flow of an oxidant to the fuel cells comprising the respective set of fuel cells.

18. The method of claim 17 wherein for each of the sets of fuel cells, terminating the operation of the set of fuel cells comprises providing the flow of the fuel while ceasing the flow of the oxidant to the fuel cells comprising the respective set of fuel cells.

19. The method of claim 18 wherein for each of the sets of fuel cells, terminating the operation of the set of fuel cells further comprises ceasing the flow of the fuel after ceasing the flow of the oxidant to the fuel cells comprising the respective set of fuel cells.

20. The method of claim 16 wherein terminating operation of alternating ones of the sets of fuel cells each time the demand for power is below the crossover threshold comprises terminating operation of each of the sets of fuel cells comprising the fuel cell system in succession.

21. The method of claim 16 wherein terminating operation of alternating ones of the sets of fuel cells each time the demand for power is below the crossover threshold comprises terminating operation of each of a number of the sets of fuel cells comprising a subset of the fuel cell system in succession.

22. The method of claim 16 wherein the fuel cell system further comprises at least two switching devices, at least one switching device electrically coupled to each of the sets of fuel cells, the method further comprising:
controlling the switch coupled to the non-operating set of fuel cells such that the voltage across the non-operating set of fuel cells remains below the open circuit voltage of the non-operating set of fuel cells.
